(19) United States
(12) Patent Application Publication
(10) Pub. No.: US 2016/0033202 A1
(43) Pub. Date: Feb. 4, 2016

(54) Door Assembly for Use with a Furnace

(71) Applicants: Vareck Walla, Katy, TX (US); Rhett Walla, Katy, TX (US); Rick Walla, Katy, TX (US)

(72) Inventors: Vareck Walla, Katy, TX (US); Rhett Walla, Katy, TX (US); Rick Walla, Katy, TX (US)

(21) Appl. No.: 14/446,781

(22) Filed: Jul. 30, 2014

(51) Int. Cl. F27D 1/18; F27D 21/02

(52) U.S. Cl. CPC F27D 1/1858; F27D 21/02; F27D 2021/023

(57) ABSTRACT

A door assembly for use with a furnace having a furnace wall and a door opening through the furnace wall. The door assembly includes a ceramic body with at least one aperture therethrough and a metal door facing secured to the ceramic body, the metal door facing having an aperture in register with the bore in the body. At least one of a peep hole assembly or a probe assembly is connected to the door assembly such that the interior of the furnace can be viewed through the peep hole assembly or the probe can be exposed to internal conditions in the furnace.

### FIELD OF THE INVENTION

The present invention relates to inspection of process furnace interiors and, more particularly, to a door assembly for use in such inspection.

### BACKGROUND OF THE INVENTION

Process heaters are a critical component in the refining and chemical industries. Traditional means of monitoring these high temperature vessels, often rely on highly subjective analysis and/or frequently inaccurate thermocouple data. An imaging radiometer specifically designed for heater inspections can be used to provide valuable performance information from operating heaters. In the hands of a knowledgeable thermographer, accurate data can be obtained and utilized to significantly increase heater throughput while helping to ensure safe operation of the heater.

Most problems in heaters used in the refining and chemical process industries are associated with upsets in day-to-day operations. These upsets range from burner malfunctions to loss of feed stock through the furnace. It is common to use infrared thermography after an upset in order to establish that the furnace is continuing to operate normally.

Another common problem associated with furnaces is refractory break down which is the loss of the insulating layer directly inside the exterior metal of the furnace. This metal will suffer degradation if exposed directly to the temperatures present in the furnace.

In many furnace designs, flame patterns tend to obstruct naked eye viewing of the tubes, precluding visual inspection of the tubes. Accordingly properly equipped thermal imagers may be utilized to obtain imaging of the interior of the furnace, even through visually opaque flame. The internal temperatures of the furnace can be very high e.g., 3000° F. and greater, which is deleterious to the steel tubes in the furnace. Another problem experienced by the furnace tubes is exposure to excessive temperatures caused by burner misalignment resulting in direct impingement on furnace tubes which can cause overheating.

Tube movement is another condition which is experienced in heaters. Most furnaces are built with the notion of tube shifting over time. However if there is excessive movement of the tubes severe problems can result. Thermal imaging has been shown to be a successful way to watch for and monitor tube movement. However, to be effective this thermal energy must be taken from the same place and compared, over time, to allow for accurate indication of tube movement or other problems.

For non-contact measurement of temperature in the furnace it is known to use a hand held emissivity correcting infrared (IR) thermometer which uses pulsed laser technology to precisely measure the true target temperature.

Additional problems that can be experienced by the furnace tubes are leaks which vent the process fluid to the interior of the furnace. While small leaks may cause no immediate harm. If the leak continues and pressure loss continues to increase, catastrophic failures can occur.

Furnaces of the type under consideration have a limited sight area allowed by the peep doors. Still, opening the peep door allows a massive amount of radiant energy to escape the furnace. This can pose a serious safety problem to a thermographer with a hand held thermal imaging device attempting to measure the temperature or inspect the interior of the furnace. Furthermore, it is difficult using a hand held device to ensure that the point of interest in the furnace can be repeatedly inspected at the same location so the condition e.g., temperatures, at that point can be accurately determined.

### SUMMARY OF THE INVENTION

In one aspect the present invention provides a door assembly having a mounting for positioning a thermal imaging device such that the interior of the furnace can be accurately inspected.

In still another aspect, the present invention relates to a door assembly for use with a process furnace which provides a mounting for a probe assembly to evaluate internal conditions in the furnace.

In another aspect the present invention is related to a peep door assembly which can include either or both of a sight glass or a mounting for a suitable probe assembly e.g., a thermal imaging device.

In yet a further aspect, the present invention relates to a door assembly for use with a process furnace wherein probe assembly e.g., a thermal imaging device, can be articulated to view desired locations on the interior of the furnace.

These and further features and advantages of the present invention will become apparent from the following detailed description, wherein reference is made to the figures in the accompanying drawings.

### BRIEF DESCRIPTION OF THE DRAWINGS

FIG. 1 is a front, elevational view of one embodiment of the door assembly of the present invention mounted on the exterior of a furnace housing.

FIG. 2 is a side elevational view, partly in section, showing the door assembly of FIG. 1 and the door opening into the furnace.

FIG. 3 is an enlarged cross-sectional view of a door assembly shown in FIGS. 1 and 2 and showing in greater detail how a thermal imager/sensor is mounted on the door assembly.

FIG. 4 is a view similar to FIG. 1 showing another embodiment of the door assembly of the present invention and

FIG. 5 is a view similar to FIG. 3 showing the embodiment of the door assembly depicted in FIG. 4.

### DETAILED DESCRIPTION OF PREFERRED EMBODIMENTS

As used herein, the word “probe” or “probe assembly” is intended to mean any type of sensor or other device that can respond, detect or monitor a physical stimulus as for example heat, light, sound, pressure, motion, compositional condition or the like and which, ideally, but not necessarily, can transmit a resulting impulse, signal or the like as for measurement, operating a control, recording, or the like. The term “compositional condition” refers to the make-up of the environment or amount of components, to which the probe assembly is exposed. As used herein, the term “thermal imaging device” or variants thereof includes a device which can make non contact measurements of the internal temperate of a furnace or other heated enclosure as well as a thermal imaging camera or other types of IR imaging radiometers.

Referring first then to FIGS. 1-3 there is shown one embodiment of the present invention. As seen in FIG. 1, the door assembly shown generally as 10, which has a metal door facing 10A, is mounted to the outside metal shell 14 of a furnace wall W or other enclosure by means of a frame 12 which is secured to shell 14 by means of bolts 16 threaded into shell 14. As seen, door assembly 10 is hingedly secured to frame 12 via hinge 18. There is a latch shown generally as 20 well known to those skilled in the art, having a first portion 20A mounted on door facing 10A and a second portion 20B which is connected to but rotatable with respect to portion 20A. Portion 20A carries a pin (not shown) about which portion 20B can rotate in a direction away from door assembly 10 i.e., out of the plane of the paper as shown in FIG. 1. Secured to frame 12 is a hook (not shown) which mates with a hook (not shown) on portion 20B when the door assembly 10 is in the closed position as shown in FIG. 1. Attached to portion 20B is a handle 22 which is in turn connected by a pivot 26 to a spring 24 having an eye 28. A spring being used to reduce heat transfer from door assembly 10 and furnace wall 14. To open door assembly 10, a hook of an appropriate type could be threaded into eye 28 of spring 24 to rotate handle 22 in the manner described above i.e., away from door assembly 10. Such a movement would rotate the hook on portion 20B out of engagement with the hook mounted or frame 12 and disengage the mating hooks whereby door assembly 10 could be opened to expose the interior of the furnace.

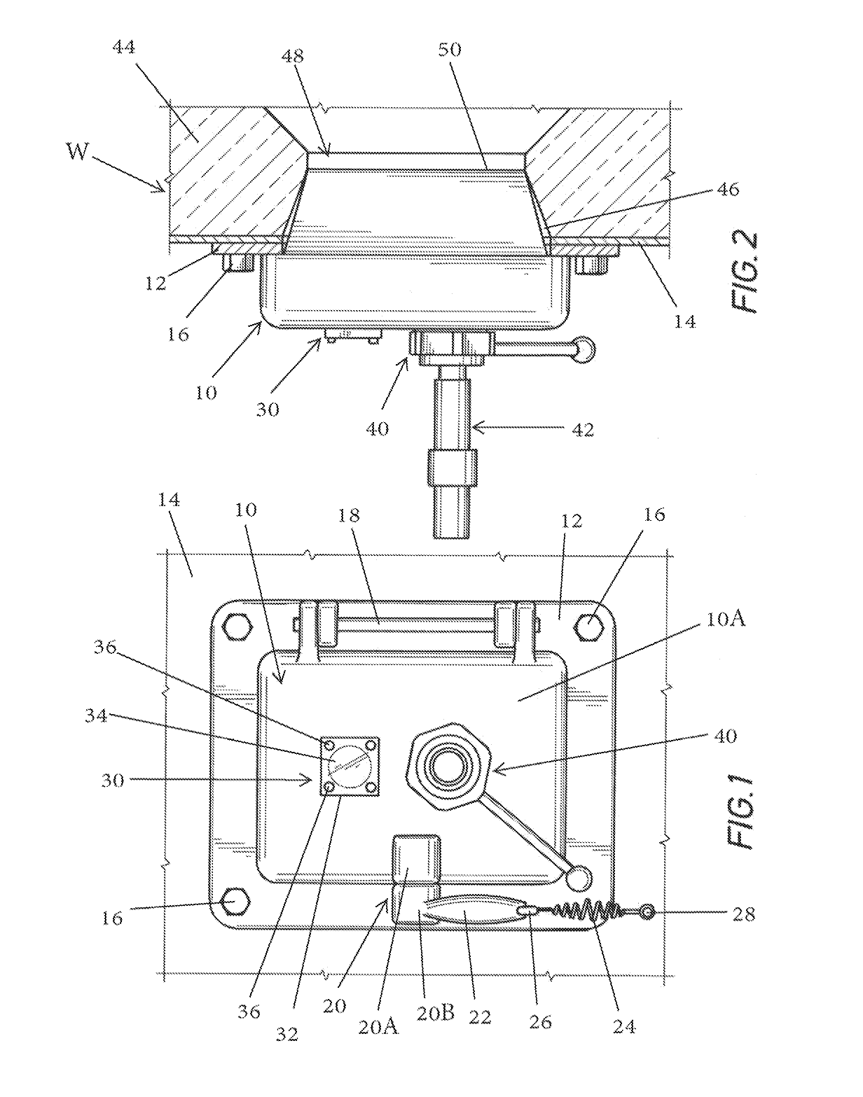

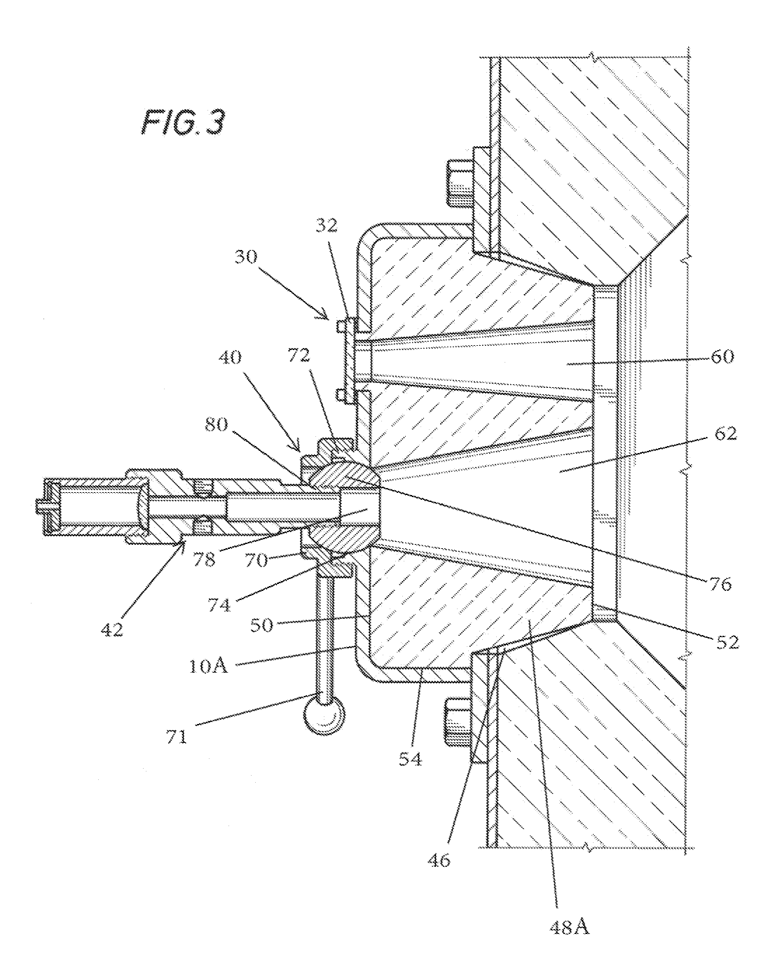

Mounted on the metal door face 10A is a peep hole assembly shown generally as 30. As seen more clearly in FIGS. 2 and 3, peep hole assembly 30 comprises a frame 32 in which is mounted a suitable high temperature sight glass 34 which allows the interior of the furnace to be visually observed without opening door assembly 10. As seen, frame 32 is attached to door facing 10A via bolts 36.

In the embodiment shown in FIGS. 1, 2 and 3, there is a probe assembly mount shown generally as 40 and described more fully hereafter for mounting a probe assembly of a desired type on door assembly 10.

Turning now to FIGS. 2 and 3, the door assembly of the present invention is shown in greater detail. The furnace wall W, as is conventional, includes an interior lining 44 made of a refractory material, the refractory lining 44 being encased in metal shell 14. There is a door opening 46 formed in the wall W of the furnace. Door assembly 10 includes a refractory or ceramic body 48, which can be vacuum formed, at least a portion of which projects into door opening 46 as shown in FIGS. 2 and 3. Body 48 has a front surface 50, a back surface 52 and a peripheral surface 54 formed between front surface 50 and back surface 52. As best seen in FIG. 3, body 48 has a tapered portion 48A which projects into the door opening 46 formed in the wall W of the furnace. As seen in FIG. 3, body 48 has a tapered bore 60 which extends from and through back surface 52 to and through front surface 50. The sight glass lens 34 in peep hole assembly 30 overlies bore 60 to allow viewing access to the interior of the furnace without opening door assembly 10. Body 48 also has a second, tapered bore which, like bore 60, extends through body 48 and provides open access through back face 52 to the interior of the furnace.

Probe assembly mount 40, as shown, comprises a nut 70 which is internally threaded and which is threadedly received on an externally threaded nipple 72 protruding from facing 10A. Nut 70, which substantially forms a housing, acts in combination with nipple 72 to form a receptacle 74 for receipt of a substantially spherical probe assembly holder 76. Holder 76 has a throughbore 78, a portion of which is threaded. Threadedly received into the threaded portion of throughbore 78 is the threaded nose 80 of a probe assembly 42. As noted above, probe assembly 42 can be one of many types of sensing devices including a laser eye for non-contact temperature measurements in the furnace as well as a thermal imaging device which can take an IR image of the internals of the furnace showing tubes, refractory walls, surfaces etc. Since the probe assembly 42 is connected to the spherical probe assembly holder 76, it can be moved in receptacle 74 formed by nut 70 and nipple 72. To accomplish this, nut 70 is loosened allowing holder 76 to move. To this end, nut 70 is connected to a handle 71 which can be used to tighten and loosen nut 70. Relative to nipple 72 to thus form an articulated joint when nut 70 is loosened. This movement allows the probe assembly 42 to be aimed at any point in the furnace over a large 360° circular area. Further this ability of probe assembly 42 to be articulated over this pattern and then, once at a desired spot to be held in that position in the receptacle 74 by tightening nut 70 permits consistent, repetitive and hence accurate determination of a condition e.g., temperature of a spot in the furnace impacted by the laser, beam from a laser eye probe assembly. It can readily be appreciated that this ability to measure internals of the furnace such as internal temperature, image a particular tube or tubes, a desired location on the interior wall of the furnace or the like at a precise, location and in a repetitive manner ensures that the thermographer or other technician using the probe assembly 42 knows that the measurements made are accurate.

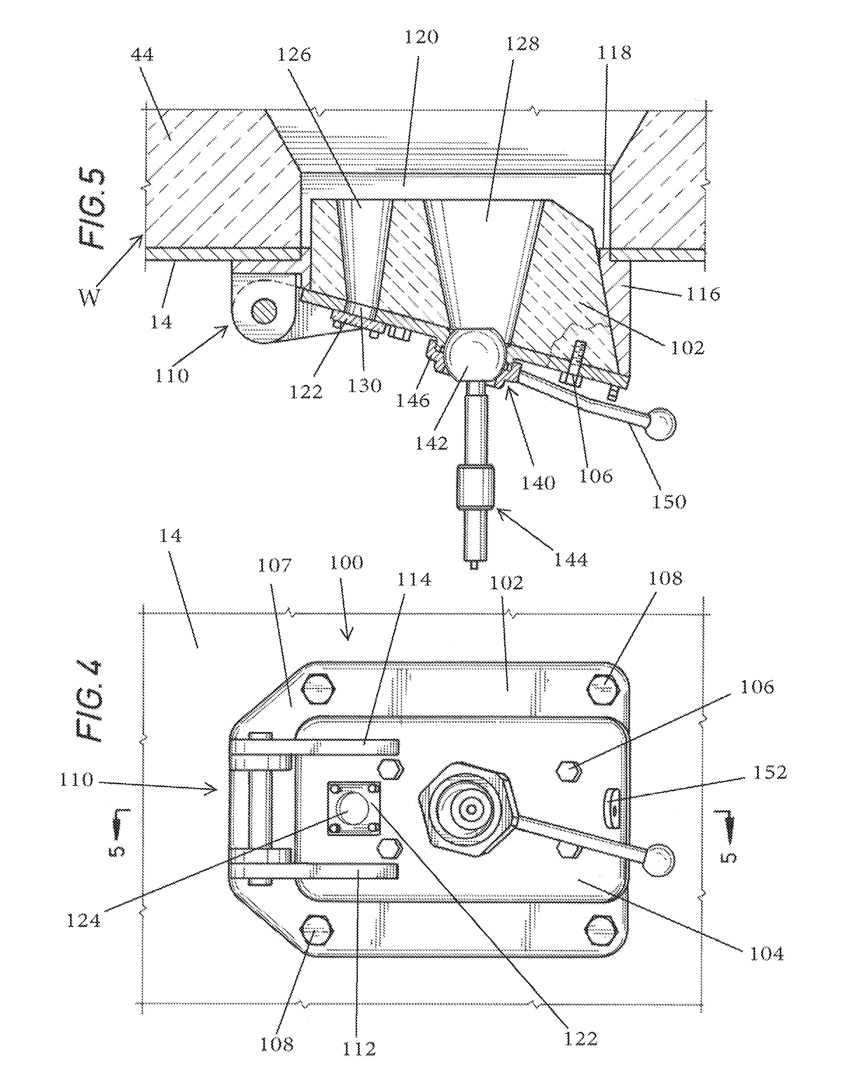

Turning now to FIGS. 4 and 5, there is shown another embodiment of the present invention. One difference in the embodiment of FIGS. 4 and 5 versus that of FIGS. 1-3 is that the door assembly of FIGS. 4 and 5 is hinged at the top rather than on the side. Firstly because of its design, the door assembly of FIGS. 4 and 5 does not require a latch assembly to maintain it in the closed position. The door assembly shown generally as 100 comprises a ceramic body 102 a metal facing 104 secured to body 102 by bolts 106 which extend through door facing 104 and are tapped into body 102 (see FIG. 5). Alternatively, and in lieu of bolts, threaded anchors could be employed, the threaded anchors being received in the body 102 and secured to the door facing by means of lock nuts as is well known to those skilled in the art. It will also be appreciated that high temperature adhesives could be used to adhere the door facing to the body; however, the use of adhesives does not allow for easy removal of the facing from the body. There is a frame 106 which is secured by bolts 108 through the wall W of the furnace. A hinge assembly 110 attached to frame 106 interconnects door assembly 102 and frame 106. In this regard, hinge assembly 110 includes arms 112 and 114 which are affixed to door facing 104. Door facing 104 includes first and second side walls (not shown) which are affixed to the back side of door facing 104 as well as a bottom ledge 116 also affixed to the back side of facing 104. The side walls and ledge 116 cooperate to form a compartment into which body 102 is at least partially received. As best seen in FIG. 5, ledge 116 has a lip portion 118 which projects into the door opening 120 in wall W.

As in the case of the embodiments shown in FIGS. 1-3, there is a peep hole assembly comprised of a frame 122 in which is mounted a sight glass 124, sight glass 124 being in register with an aperture 130 in door facing 104 which in turn is in register with the portion of a bore 126 opening through the front surface of body 102. As in the case of the embodiments described above in FIGS. 1-3, there is a second bore 128 extending through body 102, bore 128 like bore 126 providing access to the interior of the furnace.

A probe assembly mount shown generally as 140 and being essentially the same as that described with respect to the embodiment of FIGS. 1-3 includes a probe assembly holder 142 which is essentially the same as the probe assembly holder 70 described above with respect to the embodiments shown in FIGS. 1-3. A probe assembly, shown generally as 144 is connected to probe assembly holder 142 in the manner described above with respect to the embodiments of FIGS. 1-3 and which can be articulated by first loosening the nut or housing portion 146 of probe assembly mount 140 and then moving handle 150 again as described above with respect to the embodiments of FIGS. 1-3.

In order to open door assembly 100, there is a loop plate 152 attached to door facing 104 which could have a coil handle as shown in the emobodiments of FIGS. 1-3 attached to the hole in loop plate 152 whereby the eye in the coil handle can be grasped with a hook or the like and then pulled in a direction away from frame 102. It should be noted that with respect to the embodiments shown in FIGS. 4 and 5, because of the configuration of the body 102, when the door assembly 100 is open, gravity exerts a downward force on door assembly 100 such that when it is desired that door assembly 100 be closed, it can simply be slowly released and will move to the closed position. In this regard the center of gravity of the door assembly is on the lower portion of door assembly 100 e.g., close to ledge 116, thus door assembly 100 will freely swing downwardly and inwardly until the lip 118 of ledge 116 engages the opening in the metal shell 114 of wall W. It will be appreciated that the door assembly 100 could be hinged from the bottom end.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A door assembly for use with a furnace having a furnace wall and a door opening through said furnace wall comprising:
a ceramic body having a front surface, a back surface, and a peripheral surface formed between said front and back surfaces, and said body being adapted to at least partially extend into said door opening in said furnace wall, said ceramic body having at least one bore extending through said front and back surfaces;
a metal door facing secured to said ceramic body, said door facing overlying at least a portion of said front surface of said ceramic body and having at least one aperture in register with said bore, and; at least one of:
(1) a peep hole assembly connected to said door assembly and having a sight glass overlying said aperture in said door facing whereby the inside of said furnace can, be observed through said lens, said aperture and said at least one bore in said door opening or.
(2) a probe assembly connected to said door assembly and having a sensor exposed to the inside of said furnace.

2. The door assembly of claim 1 wherein said body has a second bore extending through said front and back surfaces.

3. The door assembly of claim 2 wherein said sight glass overlies said at least one bore and said probe assembly that has at least a portion in register with said second bore.

4. The door assembly of claim 3 wherein there is a probe assembly mount secured to said door assembly, said probe assembly mount having an opening therethrough in open communication with said second bore.

5. The door assembly of claim 4 wherein said probe assembly mount comprises a housing connected to said door assembly, said housing and a portion of said door facing forming a receptacle.

6. The door assembly of claim 5 wherein there is a probe assembly holder in said receptacle.

7. The door assembly of claim 6 wherein said probe assembly holder has a throughbore in register with said second bore and said opening in said probe holder.

8. The door assembly of claim 7 wherein said throughbore in said probe assembly holder is adapted to connect to at least a portion of a probe assembly.

9. The door assembly of claim 5 wherein said housing is rotatably connected to said door assembly.

10. The door assembly of claim 9 wherein there is a handle connected to said housing.

11. The door assembly of claim 6 wherein said probe assembly holder is selectively moveable in said receptacle.

12. The door assembly of claim 11 wherein said door facing has an externally threaded nipple in register with said second bore and said housing has an internally threaded portion for threadedly attaching to said nipple.

13. The door assembly of claim 12 wherein said housing can be selectively tightened on said nipple to hold said probe assembly holder in a fixed position or selectively loosened to permit articulation of said probe assembly holder.

14. The door assembly of claim 1 further comprising a hinge assembly having a first portion connected to said door facing and a second portion adapted to be connected to said furnace wall.
